(19) United States
(12) Patent Application Publication
(10) Pub. No.: US 2014/0005722 A1
(43) Pub. Date: Jan. 2, 2014

(54) PACIFIER TETHER, KIT AND METHOD

(71) Applicant: JENNIFER WHELAN, ORLANDO, FL (US)

(72) Inventor: JENNIFER WHELAN, ORLANDO, FL (US)

(21) Appl. No.: 13/536,286

(22) Filed: Jun. 28, 2012

(51) Int. Cl. A61J 17/00; D05B 97/00; B23P 23/04

(52) U.S. Cl. 606/234; 29/33 R; 112/475.01

(57) ABSTRACT

A pacifier tether includes an elongated member having a first attachment unit secured onto one end and a second attachment unit secured onto the other end. The ends and the attachment members forming a pair of loops for removably engaging external items.

### TECHNICAL FIELD

The present invention relates generally to retention devices, and more particularly to an improved tether for securing a pacifier to a baby, and a kit and method for making the same.

### BACKGROUND

The statements in this section merely provide background information related to the present disclosure and may not constitute prior art.

Babies and children are not picky about what they chew, and will often put dirty toys, and other random objects into their mouths. Often times these objects carry germs that can make a baby sick, or may constitute a choking hazard. As any parent will attest, keeping their baby safe and healthy is always the number one goal. For this reason, parents often provide their babies with pacifiers in an effort to provide a safe and sanitary device onto which a baby can chew, thus relieving the discomfort associated with teething, and to accommodate the natural sucking/feeding desires.

Unfortunately, it is not uncommon for the child's pacifier to become separated from the child. This can occur when the child spits out the pacifier, or by dropping the pacifier out of the stroller and/or car seat. In each of these instances, the pacifier may not be readily available to the needy child, or to the parent trying to manage a screaming baby. Moreover, whenever the pacifier becomes separated from the child, it is impossible to know if it has become contaminated through contact with foreign objects such as the floor and the like.

Accordingly, it would be beneficial to provide a pacifier tether capable of securing any type of pacifier to a child in order to remove the above noted drawbacks. Additionally, it would be beneficial to introduce a kit for allowing a parent to create customized pacifier tethers that can accommodate their child's particular needs and likes.

### SUMMARY OF THE INVENTION

The present invention is directed to a pacifier tether. One embodiment of the present invention can include an elongated member having a first attachment unit secured onto one end and a second attachment unit secured onto the other end. The ends and the attachment members can form a pair of loops for removably engaging external items.

Another embodiment of the present invention can include a kit for constructing a pacifier tether.

Yet another embodiment of the present invention can include a method of constructing a pacifier tether.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a top view of a pacifier tether in accordance with one embodiment of the present invention.

FIG. 2 is a side view of the pacifier tether in accordance with one embodiment of the present invention.

FIG. 3 is a perspective view of the pacifier tether in accordance with another embodiment of the present invention.

FIG. 4 is a perspective view of the pacifier tether in operation, in accordance with one embodiment.

FIG. 5 is a perspective view of a pacifier tether kit in accordance with one embodiment of the present invention.

FIG. 6 is a block diagram flow chart illustrating a method of constructing a pacifier tether in accordance with one embodiment of the present invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Although described throughout this document as a pacifier tether, one of skill in the art will recognize that the inventive concepts disclosed herein can be utilized to keep any number of child products (i.e., bottles, Sippy cups, for example). Accordingly, the device is not intended to be limited to only one use. For purposes of this description, the terms “upper,” “bottom,” “right,” “left,” “front,” “vertical,” “horizontal,” and derivatives thereof shall relate to the invention as oriented in FIG. 1.

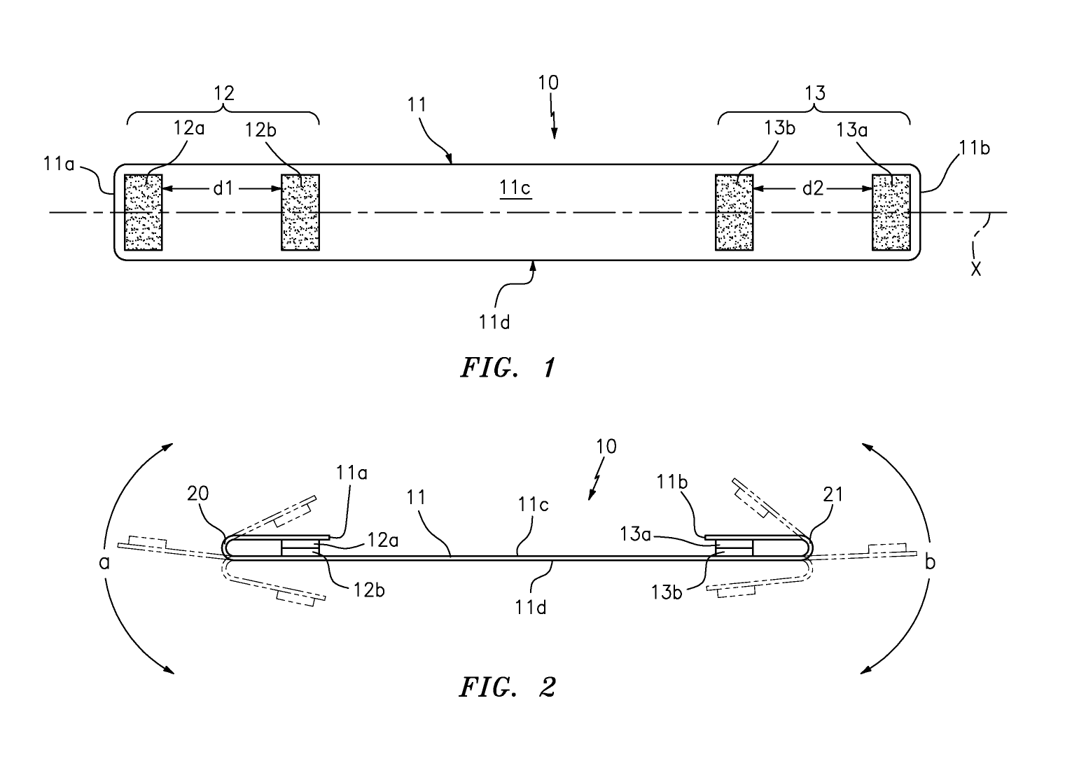

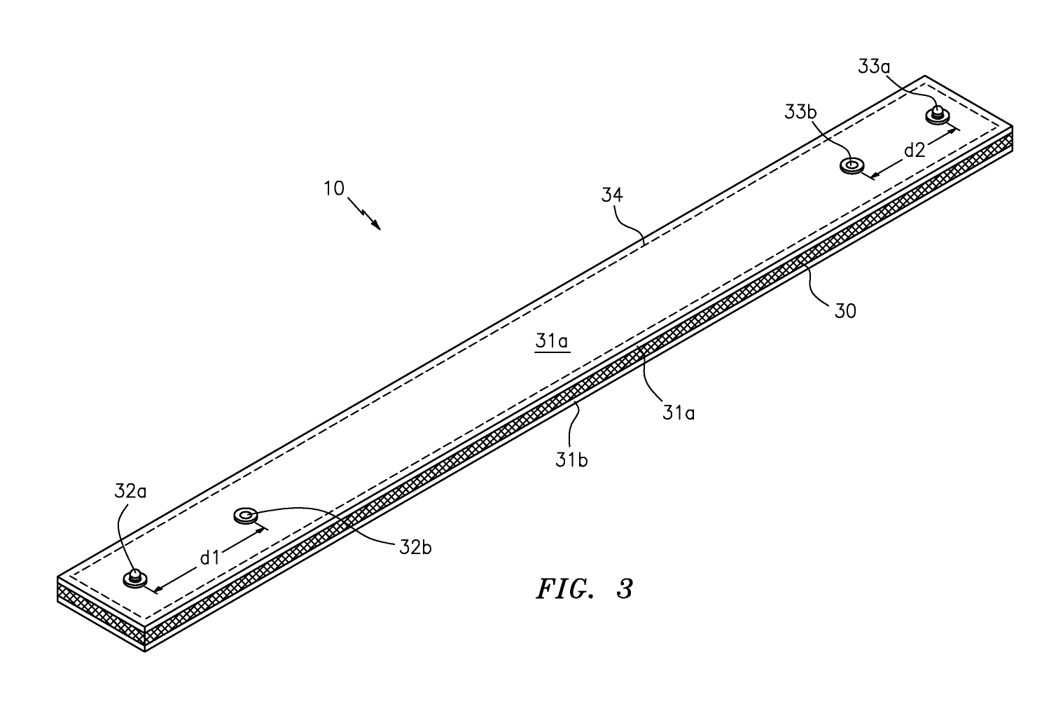

FIGS. 1 and 2 illustrate one embodiment of a pacifier tether 10 that is useful for understanding the inventive concepts disclosed herein. The tether 10 can include a main body 11, a first and second attachment unit, and an optional stabilizer.

The main body 11 can preferably include an elongated piece of malleable ribbon, fabric or polypropylene webbing having a first end 11a, a second end 11b, a top surface 11c and a bottom surface 11d.

A first attachment unit 12 can be secured onto the main body adjacent to the first end 11a, and a second attachment unit 13 can be secured onto the main body adjacent to the second end 11b.

In one preferred embodiment, the first attachment unit 12 can include opposing strips of hook and loop material (i.e., Velcro®) 12a and 12b that are separated by a first distance d1. Likewise, the second attachment unit 13 can include opposing strips of hook and loop material (i.e., Velcro®) 13a and 13b that are separated by a second distance d2. As shown in FIG. 2, the first and second attachment units 12 and 13 can be configured to selectively engage, see arrows a and b, thus forming removable and adjustable loops 20 and 21, respectively.

In one embodiment, distances d1 and d2 can be identical, in order to form loops 20 and 21 having identical sizes. Alternatively, distances d1 and d2 can be different, in order to form loops 20 and 21 having different sizes. Such a feature may be beneficial for allowing loop 20 to be small in nature for engaging a pacifier, and loop 21 be large in nature for securing to a highchair, car seat and/or stroller, for example.

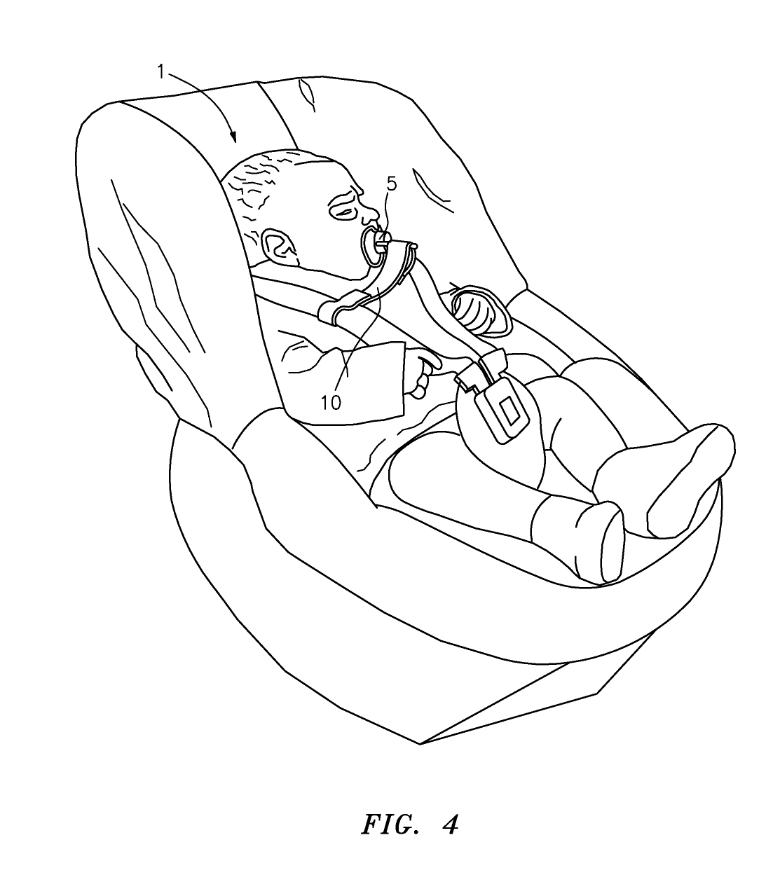

Although described above as including strips of hook and loop material, those of skill in the art will recognize that the first and second attachment units can include other known devices capable of removably securing two objects together. Several non-limiting examples include magnetic elements and compression fittings such as buttons and snaps, see elements 32 and 33 in FIG. 3. Each of these items can be permanently secured to each end of the main body 11 by a permanent sealer such as glue, adhesive tape, or stitching, for example.

To this end, the attachment units can function to form the loops 20 and 21 on either the top surface of the main body 11c or the bottom surface of the main body 11d (see also arrows a and b of FIG. 2).

While the dimensions of the elements are not critical, in the preferred embodiment the main body 11 can include a length of between 8 and 12 inches, and a width of between ¼ inch and 1 ½ inches. Likewise, distances d1 and d2 can preferably include a length (across the X axis) of approximately 1 ¼ inches apiece. Of course, other dimensions are also contemplated.

FIG. 3 illustrates an alternate embodiment of a tether 10 that further includes a stabilizer material 30 that is secured within the main body 11. As described herein, stabilizer material 30 can include an elongated strip of nylon webbing capable of greatly increasing the overall strength of the tether, while maintaining its ability to bend at the ends.

In one preferred embodiment, the stabilizer 30 is interposed between two elongated strips of malleable ribbon or fabric 31a and 31b. These layers being permanently secured together via industrial stitching 34.

Although described above as including nylon webbing, other embodiments are contemplated. For example, layer 30 can include padding, such as neoprene, for example. Additionally, other embodiments can include fusible interfacing/Hem tape capable of securing each of the layers together.

As described herein, one or more elements of the pacifier tether 10 can be secured together utilizing any number of known attachment means such as, for example, glue, liquid sealant, heat activated materials and stitching, among others.

FIG. 4 illustrates one embodiment of the tether 10 in operation. As shown, the first loop 20 can be secured to a pacifier 5 and the second loop can be secured to the strap of a car seat 2, thus ensuring the pacifier remains within reach of the parent and/or child 1 at all times.

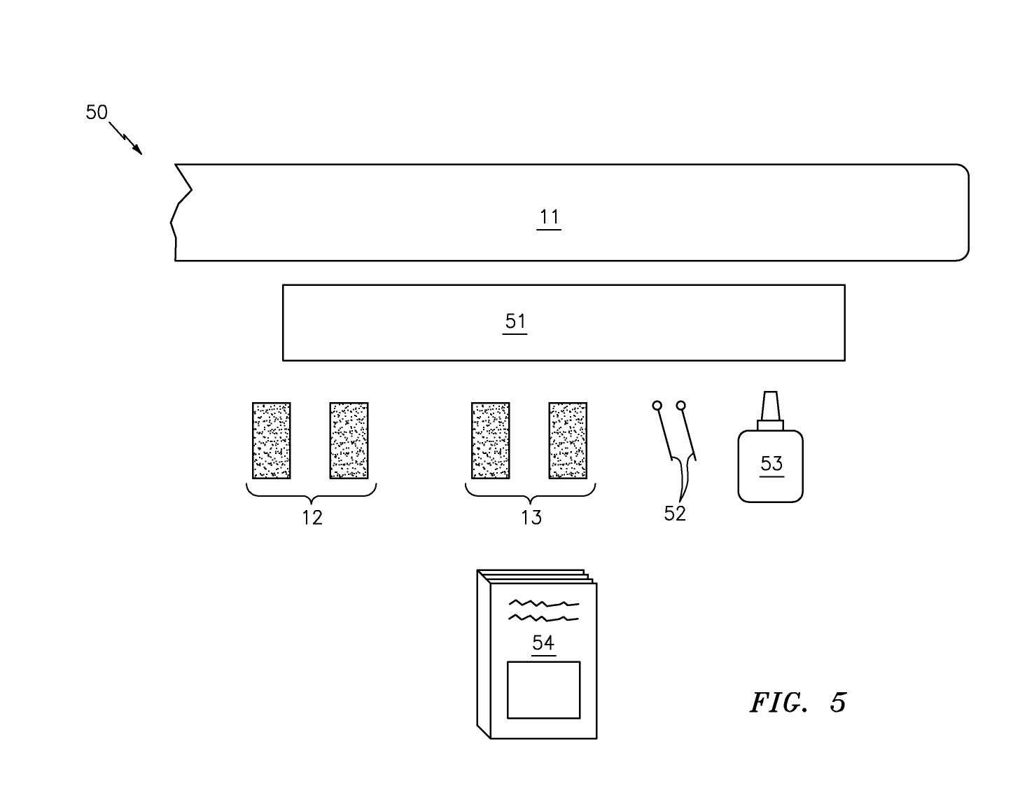

In some instances, parents may prefer to customize the tether 10 to the needs of their particular child. To this end, they may want to include a specific color, length/width of the main body and determine the type of attachment unit that works best for them. Accordingly, FIG. 5 illustrates one embodiment of a pacifier tether kit, for allowing a user to create a custom pacifier tether. The kit 50 including an elongated strand/roll of ribbon material 11, first and second attachment units 12 and 13, a length of fusible interface/hem tape 51, a pair of straight pins 52, liquid seam sealant 53 and instructions 54.

Although described above as including a pair of attachment units, the kit can include any number of additional attachment units which can be of the same type or different, as described above (i.e., snaps, buttons, magnets, etc.). This feature combined with a longer tether can act to allow a user to make multiple pacifier tethers. Additionally, although described above as including liquid seam sealant, an alternative embodiment can provide a torch or lighter to activate the fusible interface. Finally, the kit can also include one or more safety disclaimers and legal notices as required by law.

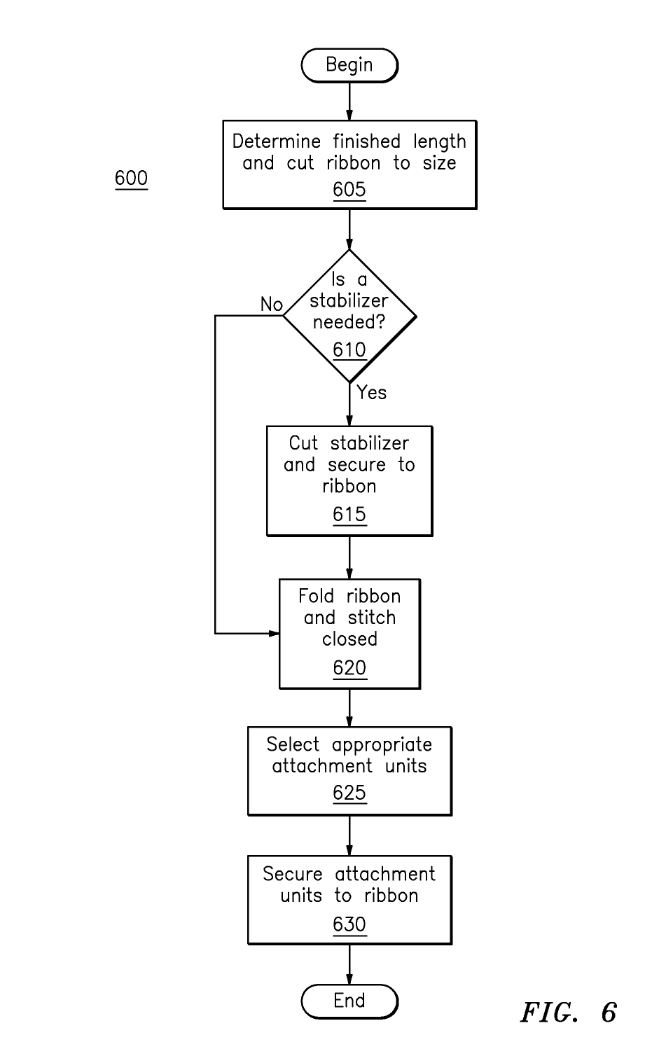

FIG. 6 is a flow chart illustrating one exemplary method 600 of making a pacifier tether 10 as described above.

The method can begin at step 605 in which a user can determine the type of material the tether is to be constructed from, and cut the same in accordance with the desired length of the tether. In step 610, a decision regarding whether or not a stabilizer is to be included will be made. If a stabilizer is not included, the method will proceed to step 620. If a stabilizer will be included, the method will proceed to step 615.

At step 615, a stabilizer material can be selected and secured onto the tether material. In one preferred embodiment, the stabilizer material will include a length that is approximately ½ of the overall length of the tether material.

At step 620, the ribbon can be folded in half lengthwise (X axis) over the top of the stabilizer material, if present and stitched along the outer periphery to form a finished shape.

In step 625, a plurality of attachment units can be selected, and in step 630 the attachment units can be affixed to the tether utilizing any number of permanent adhesion techniques.

Although described above as folding the material and stitching to form the tether without the stabilizer, other methods incorporating a single material construction are also contemplated.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A pacifier tether, comprising:
an elongated member having a top surface, a bottom surface, first end and a second end;
a first attachment unit secured onto the top surface of the elongated member at a location adjacent to the first end, said first attachment unit including a pair of connectors separated by a first distance that are configured to removably engage together,
said first end being configured to bend towards a center portion of the elongated member to form a first loop that is removably fastened by the first attachment unit;
a second attachment unit secured onto the top surface of the elongated member at a location adjacent to the second end, said second attachment unit including another pair of connectors separated by a second distance that are configured to removably engage together,
said second end being configured to bend towards a center portion of the elongated member to form a second loop that is removably fastened by the second attachment unit,
wherein each of said first and second loops are configured to securely and removably engage an external item.

2. The device of claim 1, further comprising:
a second elongated member positioned beneath the first elongated member, said second elongated member having an identical construction to the first elongated member;
a stabilizer that is interposed between the first and second elongated members; and
stitching disposed along the entirety of an outside periphery of each of the first elongated member, the second elongated member and the stabilizer, to form a single integrated main body.

3. The device of claim 2, wherein said stabilizer includes an elongated strip of nylon webbing.

4. The device of claim 1, wherein said elongated member is constructed from at least one of a ribbon, fabric and polypropylene material.

5. The device of claim 1, wherein said first attachment unit includes at least one of a pair of opposing hook and loop strips, a pair of opposing magnetic elements, and compression fittings.

6. The device of claim 1, wherein said second attachment unit includes at least one of a pair of opposing hook and loop strips, a pair of opposing magnetic elements, and compression fittings.

7. The device of claim 1, wherein said first and second attachment units include identical type connectors.

8. The device of claim 1, wherein the first attachment unit includes connectors that are different from the connectors of the second attachment unit.

9. The device of claim 1, wherein the first distance is the same as the second distance.

10. The device of claim 1, wherein the first distance is different than the second distance.

11. The device of claim 1, wherein the first loop includes a size that is the same as the second loop.

12. The device of claim 1, wherein the first loop includes a size that is different than the second loop.

13. The device of claim 1, wherein said external item includes at least one of a pacifier, a baby bottle, a Sippy cup, a stroller, and a car seat strap.

14. The device of claim 1, wherein the elongated member includes a length of between 8 and 12 inches, and a width of between ¼ inches and 1 ½ inches.

15. A kit for constructing a pacifier tether in accordance with a users preferences, said kit comprising:
an elongated strand of ribbon material configured to be cut into a plurality of strips, having varying lengths;
a plurality of attachment units configured to be secured to one or more of the strips;
a pair of straight pins for positioning each of the strips and plurality of attachment units together in a desired configuration;
an elongated strand of fusible hem tape configured to bind each of the strips and the attachment units together;
a liquid sealant configured to activate the hem tape; and
instructions for guiding a user to create the pacifier tether.

16. A method of constructing a pacifier tether, comprising:
selecting an elongated strand of ribbon material;
cutting the chosen material to a first length;
folding the ribbon material to form two equal halves;
stitching the ribbon halves together
selecting a first and second attachment unit; and
securing the first and second attachment units to a first and second end of the ribbon halves, respectively.

17. The method of claim 16, further comprising:
choosing a stabilizer material;
cutting the stabilizer material to a second length, said second length being approximately ½ the distance of the first length; and
positioning the stabilizer material between the folded ribbon halves.
